(19) United States
(12) Patent Application Publication
(10) Pub. No.: US 2020/0145164 A1
(43) Pub. Date: May 7, 2020

(54) METHODS AND APPARATUSES FOR PERFORMING CHANNEL MEASUREMENTS UNDER POWER SAVING CONTROL

(71) Applicant: FG Innovation Company Limited, Tuen Mun (HK)

(72) Inventor: YU-HSIN CHENG, Hsinchu (TW)

(21) Appl. No.: 16/667,799

(22) Filed: Oct. 29, 2019

Related U.S. Application Data
(60) Provisional application No. 62/754,726, filed on Nov. 2, 2018.

(51) Int. Cl. H04L 5/00; H04B 7/06; H04L 1/00; H04W 52/26

(52) U.S. Cl. CPC H04L 5/0053; H04B 7/0626; H04W 52/265; H04L 1/0026; H04L 5/006

(57) ABSTRACT

A method of wireless communications includes receiving, at a user equipment (UE), an instruction indicating a trigger state for Channel Status Information (CSI) reporting from a base station, determining, at the UE, whether a first Bandwidth Part (BWP) associated with the trigger state is operated in a dormant state in which the UE does not perform data transmissions on the first BWP, performing, at the UE, a CSI measurement on the first BWP when the first BWP is operated in the dormant state, and transmitting, at the UE, a first CSI report for the first BWP through a second BWP that is operated in an active state.

### CROSS-REFERENCE TO RELATED APPLICATION(S)

The present application claims the benefit of and priority to a provisional U.S. Patent Application Ser. No. 62/754,726, filed on Nov. 2, 2018, entitled “Method and Apparatus for Measurement in NR Power Saving,” with Attorney Docket No. US75393 (hereinafter referred to as “US75393 application”). The disclosure of the US75393 application is hereby incorporated fully by reference into the present application.

### FIELD

The present disclosure generally relates to wireless communications, and more particularly, to methods and apparatuses for performing channel measurements under power saving control.

### BACKGROUND

Power consumption is one of the major technical concerns in wireless communications. Currently, many power saving schemes have been proposed to reduce the power consumption of the communication devices. For example, in a Long Term Evolution (LTE) system, a user equipment (UE) may enter a power saving mode when it is idle. However, as the demand for low power consumption continues to increase, there is a need for further improvements in power management in the next generation (e.g., fifth generation (5G) New Radio (NR)) wireless communication systems.

### SUMMARY

The present disclosure is directed to methods and apparatuses for performing channel measurements under power saving control.

According to an aspect of the present disclosure, a UE is provided. The UE includes one or more non-transitory computer-readable media having computer-executable instructions embodied thereon and at least one processor coupled to the one or more non-transitory computer-readable media. The at least one processor is configured to execute the computer-executable instructions to receive an instruction indicating a trigger state for Channel Status Information (CSI) reporting from a base station (BS), determine whether a first Bandwidth Part (BWP) associated with the trigger state is operated in a dormant state in which the UE does not perform data transmissions on the first BWP, perform a CSI measurement on the first BWP when the first BWP is operated in the dormant state, and transmit a first CSI report for the first BWP through a second BWP that is operated in an active state.

According to another aspect of the present disclosure, a method of wireless communications is provided. The method includes receiving, at a UE, an instruction indicating a trigger state for CSI reporting from a BS, determining, at the UE, whether a first BWP associated with the trigger state is operated in a dormant state in which the UE does not perform data transmissions on the first BWP, performing, at the UE, a CSI measurement on the first BWP when the first BWP is operated in the dormant state, and transmitting, at the UE, a first CSI report for the first BWP through a second BWP that is operated in an active state.

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a flowchart for a method of performing channel measurements, in accordance with an example implementation of the present disclosure.

FIG. 2 is schematic diagram illustrating a UE's behavior when the first type of CSI measurement procedure is performed, in accordance with an example implementation of the present disclosure.

FIG. 3 is a flowchart for a process of determining a CSI resource configuration, in accordance with an example implementation of the present disclosure.

FIG. 4 is a flowchart for a process of determining a CSI resource configuration, in accordance with an example implementation of the present disclosure.

FIG. 5 is a flowchart for a process of determining a CSI report configuration, in accordance with an example implementation of the present disclosure.

FIG. 6 is a schematic diagram illustrating an example architecture of a BS, in accordance with an example implementation of the present disclosure.

FIG. 7 is a schematic diagram illustrating an example architecture of a UE, in accordance with an example implementation of the present disclosure.

FIG. 8 is a schematic diagram illustrating a number of BWPs configured in different Component Carriers (CCs), in accordance with an example implementation of the present disclosure.

FIG. 9 is a block diagram illustrating a node for wireless communication, in accordance with an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G New Radio (NR) Radio Access Network (RAN)) typically includes at least one BS, at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects, and represents that three relationships may exist. For example. A and/or B may indicate that: A exists alone, A and B exist at the same time, or B exists alone. In addition, the character “I” herein generally represents that the former and latter associated objects are in an “or” relationship.

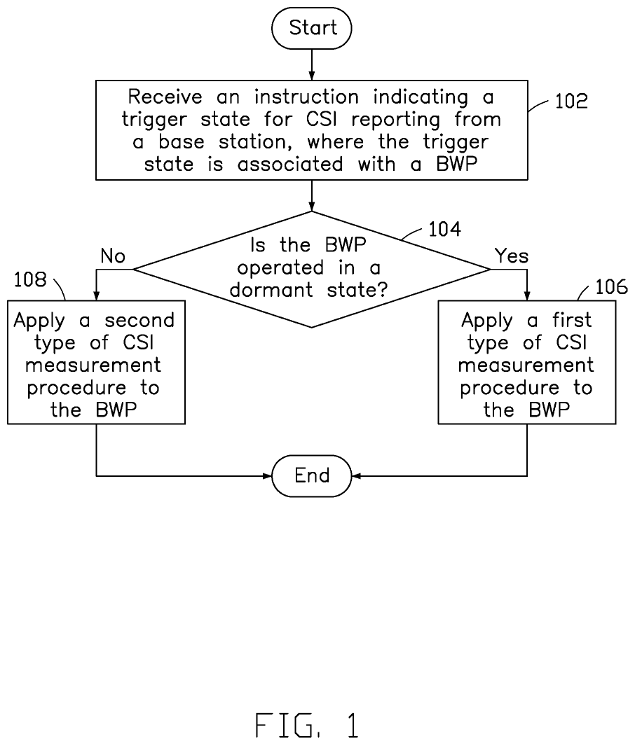

FIG. 1 is a flowchart for a method of performing channel measurements, in accordance with an example implementation of the present disclosure.

In action 102, a UE may receive, from a base station, an instruction indicating a trigger state for CSI reporting. The trigger state may be associated with a BWP. In some of the present implementations, the BWP may be (but not limited to) an initial DL BWP of a cell.

In action 104, the UE may determine whether the BWP is operated in a dormant state. In some of the present implementations, a BWP may be in the dormant state when the UE does not (or is not allowed to) perform data transmissions on the BWP, and/or when the UE is only allowed to perform CSI measurements on the BWP.

In action 106, if the BWP is operated in the dormant state (also referred to as a “dormant BWP”), the UE may apply a first type of CSI measurement procedure to the dormant BWP. In some of the present implementations, the first type of CSI measurement procedure may include performing, at the UE, a CSI measurement on the dormant BWP, and transmitting, by the UE, a CSI report for the dormant BWP through another BWP that is operated in an active state (also referred to as an “active BWP”). On the dormant BWP, the UE may not perform data transmissions in order to reduce the power consumption. In some of the present implementations, a BWP/SCell may be a dormant BWP/SCell when a UE performs sparse or no Physical Downlink Control Channel (PDCCH) monitoring on the BWP/SCell, while the UE continues to perform the CSI measurement procedure for the BWP/cell. In some of the present implementations, the CSI report may be an aperiodic CSI report or a semi-persistent CSI report.

In action 108, if the BWP is not in the dormant state (e.g., the BWP is an active BWP), the UE may apply a second type of CSI measurement procedure to the BWP. The second type of CSI measurement procedure may be a normal CSI measurement procedure for an active BWP/cell, in which the UE may report the CSI report through the active BWP/cell on which the CSI measurement(s) is performed.

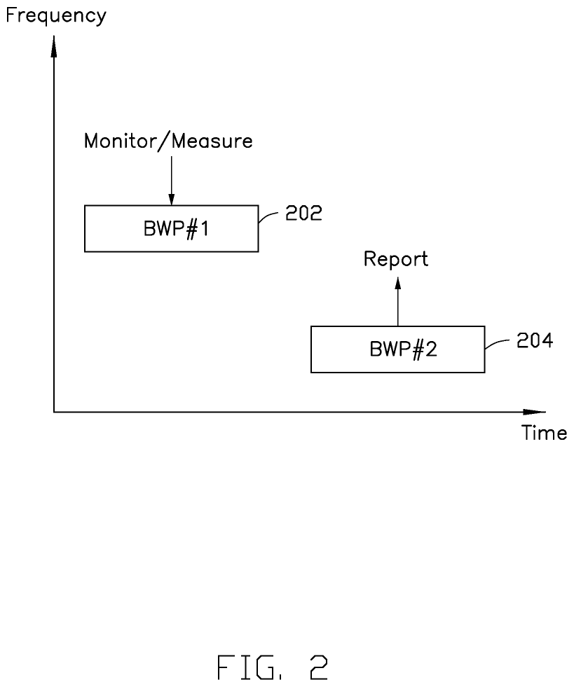

FIG. 2 is schematic diagram illustrating a UE's behavior when the first type of CSI measurement procedure is performed, in accordance with an example implementation of the present disclosure. In the example implementation, BWP #1 202 is a dormant BWP and BWP #2 204 is an active BWP. As shown in FIG. 2, even though data transmissions on BWP #1 202 may be restricted or prohibited due to BWP #1 202 being operated in the dormant state, the UE may perform a CSI measurement/monitoring procedure on BW1#1 202, and report a corresponding measurement result (e.g., a CSI report) to the BS via BWP #2 204. In FIG. 2. BWP #1 202 and BWP #2 204 do not have an overlapped portion in the time domain. In some other implementations, the BWP that is measured/monitored by the UE and another BWP, through which the UE transmits the CSI report, may overlap in at least one symbol in the time domain.

In some of the present implementations, a UE may determine the measurement target (or CSI resources) for a Secondary Cell (SCell) that is in the dormant state (also referred to as a “dormant SCell”) based on an RRC signaling. The measurement target may be one or more RSs to be measured by the UE, and the corresponding measurement result(s) of the measurement target may be included in a CSI report.

In some of the present implementations, a UE may monitor at least one RS for a dormant SCell based on one or more BWP indices (e.g., BWP Identities (IDs)). The one or more BWP indices may be contained in an SCell configuration (e.g., an Information Element (IE) of ServingCellConfig) of an RRC signaling. In addition, a CSI resource configuration of dormant state may be contained in an IE of CSI-ResourceConfigDormant, which may be applied to an SCell/BWP that is operated in the dormant state. In some of the present implementations, a BWP/SCell may apply different CSI resource configurations when the BWP/SCell is operated in different states. For example, the BWP/SCell may apply a CSI resource configuration for dormant state (e.g., the CSI-ResourceConfigDormant) when the BWP/SCell is in the dormant state, and apply a normal CSI resource configuration (e.g., an IE of CSI-ResourceConfig) when the BWP/SCell is not in the dormant state.

In some of the present implementations, the DL BWP, on which the measured RS is associated with the CSI-ResourceConfigDormant, may be the DL BWP that is indicated by the BWP ID contained in the SCell configuration (e.g., the ServingCellConfig of the dormant SCell) in an RRC signaling.

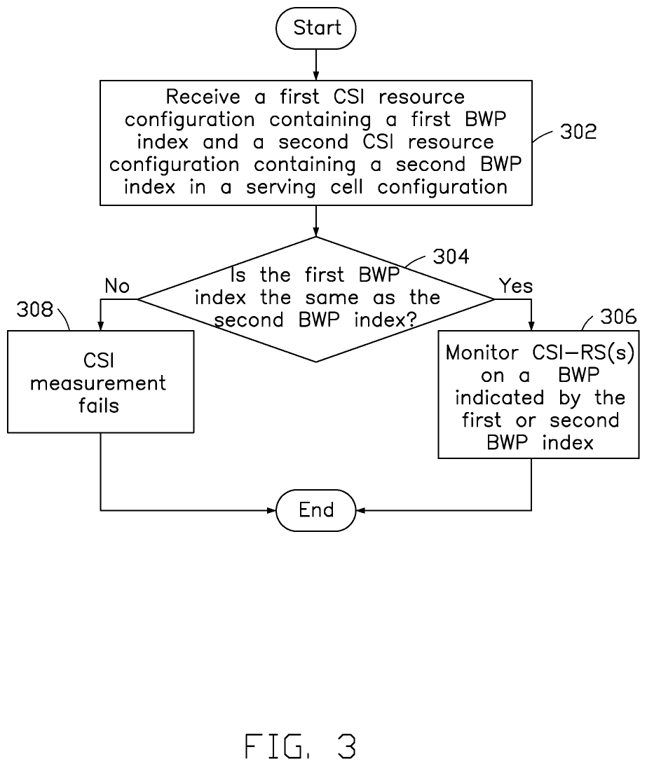

FIG. 3 is a flowchart for a process of determining a CSI resource configuration, in accordance with an example implementation of the present disclosure. As shown in FIG. 3, the flowchart includes actions 302, 304, 306 and 308.

In action 302, the UE may receive a first CSI resource configuration (which contains a first BWP index) and a second CSI resource configuration (which contains a second BWP index) in a serving cell configuration (e.g., the ServingCellConfig). In some of the present implementations, the first CSI resource configuration may include an IE of CSI-ResourceConfigDormant, and the second CSI resource configuration may include an IE of CSI-ResourceConfig.

In action 304, the UE may determine whether the first BWP index is the same as the second BWP index.

In action 306, if the first and second BWP indices are the same, the UE may monitor the CSI-RS(s) on a BWP indicated by the first or second BWP index.

In action 308, if the first and second BWP indices are different, the UE may consider that the CSI measurement has failed. Specifically, the UE may not expect that the BWP ID contained in the CSI resource configuration for dormant state (e.g., the CSI-ResourceConfigDormant) is different from that in the same SCell configuration. If the two BWP IDs are different, the UE may treat this as an error case.

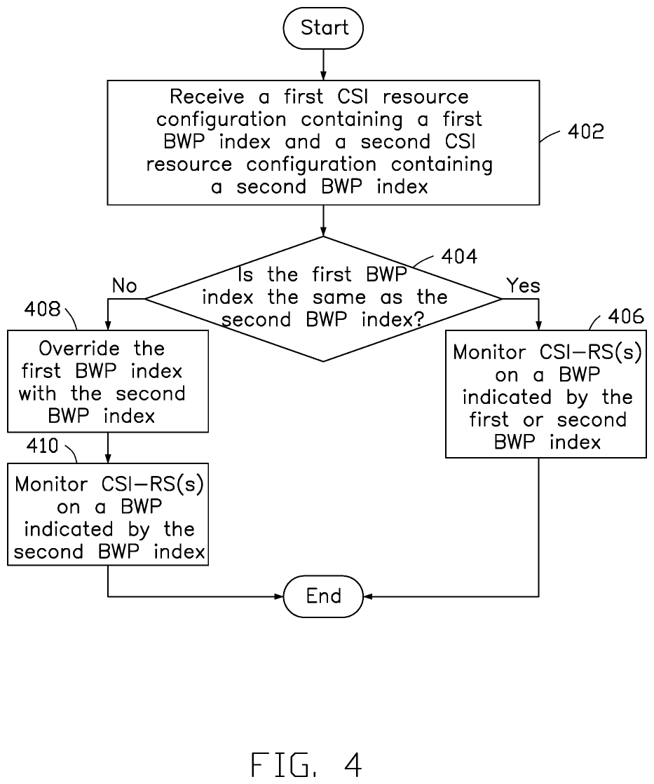

FIG. 4 is a flowchart for a process of determining a CSI resource configuration, in accordance with an example implementation of the present disclosure. As shown in FIG. 4, the flowchart includes actions 402, 404, 406, 408 and 410.

Actions 402, 404, and 406 in FIG. 4 are similar to actions 302, 304, and 306, respectively, as discussed above with reference to FIG. 3. The details of actions 402, 404, and 406 are omitted for brevity. In FIG. 4, however, if the UE determines, in action 404, that the first BWP index is different than the second BWP index, the UE may override, in action 408, the first BWP index with the second BWP index. (The UE may then monitor, in action 410, the CSI-RS(s) on the BWP (which is indicated by the second BWP index) after overriding the first BWP index with the second BWP index. For example, if the BWP ID in the CSI-ResourceConfigDormant is different from that in the ServingCellConfig (or in the CSI-ResourceConfig), the UE may override the BWP ID in the ServingCellConfig (or in the CSI-ResourceConfig) with the BWP ID in the CSI-ResourceConfigDormant. The UE may then perform a CSI measurement/monitoring procedure on the BWP indicated by the overridden BWP ID in the ServingCellConfig (or in the CSI-ResourceConfig). In some of the present implementations, the initial DL BWP of the UE may be indicated by the BWP ID contained in the CSI-ResourceConfigDormant when the SCell switches from the dormant state to the active state.

In some other implementations, the UE may override the first BWP ID (e.g., in the CSI-ResourceConfigDormant) with the second BWP ID (e.g., in the ServingCellConfig or CSI-ResourceConfig) if the first and second BWP IDs are different. In some of such implementations, the UE may perform a CSI measurement/CSI-RS monitoring procedure on the BWP indicated by the overridden first BWP ID (which equals to the second BWP ID).

In some other implementations, the UE may not be configured with a dedicated CSI resource configuration for a dormant state (e.g., the CSI-ResourceConfigDormant). In such cases, if the CSI report contains the measurement result of a serving cell that is in the dormant state, the DL BWP, on which the measured CSI-RS is associated with the CSI-ResourceConfig, may be the initial DL BWP configured in the ServingCellConfig of the dormant SCell.

In some of the present implementations, the CSI resource (or CSI resource set) may be indicated by the data in the CSI-ResourceConfigDormant.

In some of the present implementations, the UE may generate a CSI report for a dormant SCell (e.g., the CSI report includes a measurement result of the dormant SCell) based on the CSI resource configuration contained in the SCell configuration of the RRC signaling (e.g., the ServingCellConfig). The UE may further determine a corresponding CSI report configuration for dormant state (e.g., an IE of CSI-ReportconfigDormant) accordingly.

In some of the present implementations, the CSI report configuration for dormant state may have a different setting than a normal CSI report configuration (e.g., the CSI-ReportConfig).

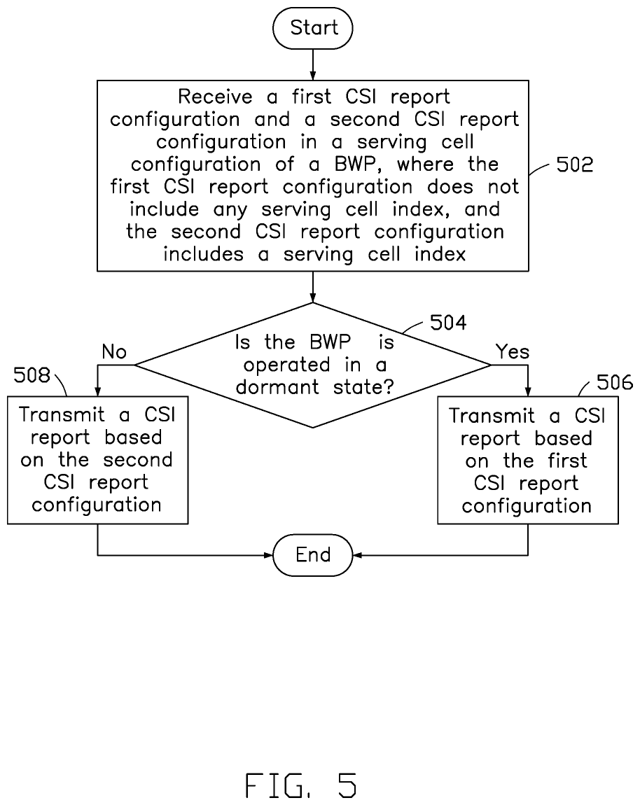

FIG. 5 is a flowchart for a process of determining a CSI report configuration, in accordance with an example implementation of the present disclosure. As shown in FIG. 5, the flowchart includes actions 502, 504, 506 and 508.

In action 502, the UE may receive a first CSI report configuration and a second CSI report configuration in a serving cell configuration (e.g., the ServingCellConfig) of a BWP/SCell. In the example implementation, the first CSI resource configuration may be a CSI report configuration for a dormant state, such as the CSI-ReportconfigDormant. and the second CSI resource configuration may be a normal CSI report configuration, such as the CSI-ReportConfig. The first CSI report configuration may not include any serving cell index, while the second CSI report configuration may include at least one serving cell index.

In action 504, the UE may determine whether the BWP/SCell is in a dormant state.

In action 506, if the BWP is a dormant BWP/SCell, the UE may transmit (to a base station) a CSI report based on the first CSI report configuration.

In action 508, if the BWP is not a dormant BWP/SCell (e.g., the BWP/SCell is in an active state), the UE may transmit a CSI report based on the second CSI report configuration.

In some of the present implementations, the CSI report configuration for dormant state (e.g., the CSI-ReportconfigDormant) may be associated with a CSI resource configuration of the same dormant SCell (e.g., the CSI-ResourceConfig in the ServingCellConfig for the same dormant SCell) when the CSI report configuration for dormant state does not include any serving cell ID.

In some of the present implementations, a UE may be configured by a BS with an indication to limit the number of CSI reports during an on-duration of a Discontinuous Reception (DRX) cycle. The UE may determine whether to transmit a CSI report within the on-duration based on the indication. In some of the present implementations, the indication may be a CSI masking parameter (e.g., an IE of CSI-mask) contained in the SCell configuration. In some of the present implementations, the value of the CSI masking parameter may be configured by the BS per a cell basis.

In some of the present implementations, the value of the CSI masking parameter configured in the SCell configuration of an RRC signaling may be the same or different from the value of the CSI masking parameter configured in the Medium Access Control (MAC) configuration per a serving cell group basis. In some of the present implementations, based on configuring the CSI masking parameter or not, the CSI reporting frequency for each SCell may be individually configured. For example, some dormant SCells may be configured with the CSI masking parameters, whereas other dormant SCells may not be configured with the CSI masking parameters. Because the UE may report less CSI reports for the SCells that are configured with the CSI masking parameters, the power consumption for the CSI reporting may be reduced.

In some of the present implementations, the CSI reports for the SCells in different states may be given different priority values. The UE may determine which CSI report to drop according to the priority values when two or more CSI report transmissions collide. In addition, the UE may use the priority values to prioritize the transmission of certain types of the CSI reports. For example, the UE may prioritize the CSI report transmission of an SCell in the active state than that of a dormant SCell. In some of the present implementations, the collision between two or more CSI reports may happen when these CSI reports are scheduled on two or more physical channels with their time occupancy overlapping in at least one OFDM symbol while being transmitted on the same carrier.

In some of the present implementations, the dormant SCell may be configured with an offset value, such that the priority value of the dormant SCell may always be lower than the priority value of the SCell in the active state if the parameters (e.g., y, k, c, s in expression (1), which will be described in the following paragraphs) used to calculate the priority values of the SCells are the same.

In some of the present implementations, a UE may determine which CSI report to drop based on the priority values if the number of CSI Processing Units (CPUs) (which may be used to process or calculate the CSI reports) within a time period exceeds a predetermined number (e.g., the maximum number of CPUs, which may be defined as the UE's capability). In some of the present implementations, the processing of a periodic/semi-persistent CSI report (obtained by measuring a periodic/semi-persistent or aperiodic CSI-RS) may occupy a CPU, for example, from the beginning of the first symbol of the earliest one of the CSI-RS/CSI-Interference Measurement (IM) resources to the end of the last symbol of a Physical Uplink Shared Channel (PUSCH)/Physical Uplink Control Channel (PUCCH) carrying the report. The respective latest CSI-RS/CSI-IM occasions may be no later than the corresponding CSI reference resource, if applicable. On the other hand, the processing of an aperiodic CSI report (obtained by measuring a periodic/semi-persistent or aperiodic CSI-RS) may occupy the CPU from the first symbol of the PDCCH triggering the CSI report to the last symbol of the PUSCH carrying the CSI report.

In some of the present implementations, the CSI resource or CSI resource set may be indicated by an index or an explicit configuration in the CSI-ResourceConfigDormant. Moreover, the CSI report configuration may be indicated by an index or an explicit configuration in the CSI-ReportConfigDormant.

In some of the present implementations, the UE may be triggered by the BS to transmit an aperiodic CSI report based on, for example, an index in the IE of CSI-report together with the associated aperiodic CSI trigger state (e.g., an IE of CSI-AperiodicTriggerState). The UE may find the corresponding CSI resource for the CSI report based on the CSI resource configuration for dormant state. For example, the CSI-ResourceConfigId contained in the CSI report may be linked to a CSI resource configured by the CSI resource configuration for dormant state. The UE may not be expected to be triggered by the BS to transmit the aperiodic CSI report for a non-active DL BWP except that the serving cell of the non-active DL BWP is in a dormant state. In some of such implementations, the aperiodic CSI reporting mechanism may be applied when the dormant SCell (of which the CSI resource configuration is associated with the triggered aperiodic CSI report) is considered as an intra-band CC having at least one active serving cell for the UE.

In some of the present implementations, the UE may be triggered by the BS to transmit a semi-persistent CSI report on a PUSCH/PUCCH based on, for example, an index in CSI-report and the associated semi-persistent CSI trigger state (e.g., the CSI-SemiPersistentOnPUSCH-TriggerState. or the CSI-ReportConfig having the reportConfigType of the semiPersistentOnPUCCH). The UE may find the corresponding CSI resource for the CSI report based on the CSI resource configuration for dormant state. For example, the CSI-ResourceConfigId contained in the CSI report may be linked to the CSI resource that is configured in the CSI resource configuration for dormant state. The UE may not be expected to be triggered by the BS to transmit the semi-persistent CSI report on a PUCCH/PUSCH for a non-active DL BWP except that the serving cell of the non-active DL BWP is in a dormant state. In such a case, transmitting a CSI report that carries the measurement result of a BWP on a PUCCH/PUSCH may take place if the BWP is an active BWP, or is not associated with a dormant SCell. Otherwise, the CSI reporting operation may be suspended. In some of such implementations, the semi-persistent CSI reporting mechanism may only be applied when the dormant SCell (of which the CSI resource configuration is associated with the triggered semi-persistent CSI report) is considered as an intra-band CC having at least one active serving cell for the UE.

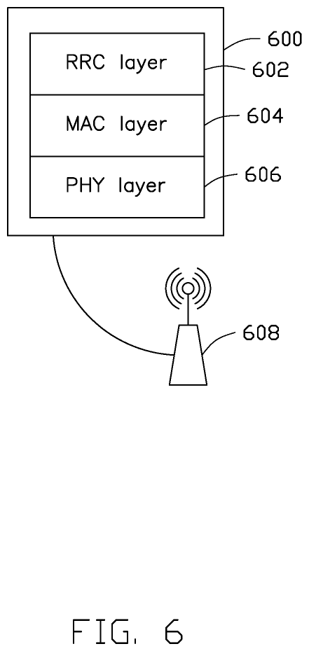

FIG. 6 is a schematic diagram illustrating an example architecture of a BS, in accordance with an example implementation of the present disclosure. As shown in FIG. 6, BS 600 may include a protocol stack that contains a number of protocol layers (e.g., Physical (PHY) layer 606, MAC layer 604, and RRC layer 602). BS 600 may control and coordinate the activities of the various protocol layers of the protocol stack. In addition, PHY layer 606 may be coupled to at least one Transmit/Receive Point (TRP) 608. TRP 608 may be a macro-cell, a small-cell, a pico-cell, a femto-cell, a Remote Radio Head (RRH), a relay node, or a combination of antenna panels, which may be deployed anywhere such as in the interior of a room, in/on a building, on top of a house or streetlamps.

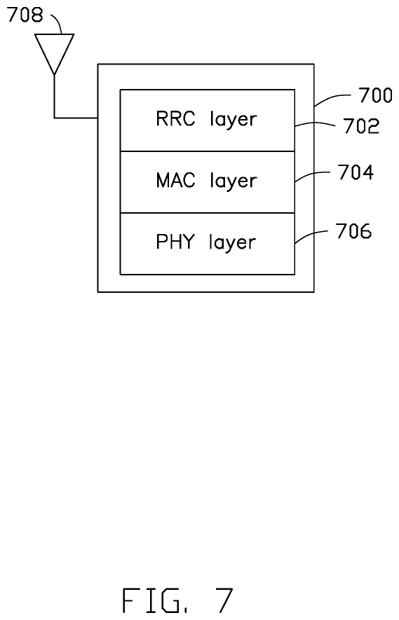

FIG. 7 is a schematic diagram illustrating an example architecture of a UE, in accordance with an example implementation of the present disclosure. As shown in FIG. 7, UE 700 may include a protocol stack that contains a number of protocol layers (e.g., PHY layer 706, MAC layer 704, and RRC layer 702). PHY layer 706 may be coupled to at least one Transmit (TX)/Receive (RX) antenna component 708 for transmitting and receiving signals. UE 700 may control and coordinate the activities of the various protocol layers of the protocol stack. For example, UE 700 may set and coordinate PHY layer 706, MAC layer 704, and RRC layer 702 based on the received signals from TX/RX antenna component 708. UE 700 may also set one or more TX parameters for TX/RX antenna component 708 based on the input signal(s).

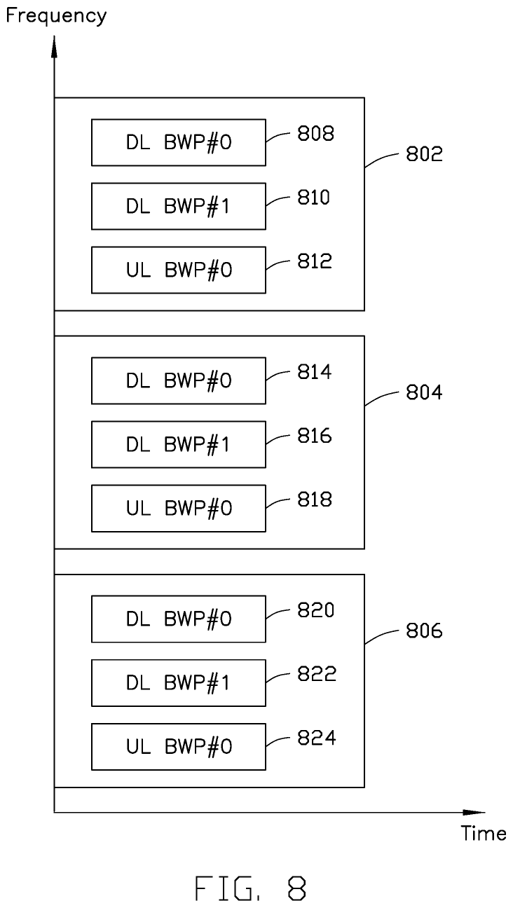

FIG. 8 is a schematic diagram illustrating a number of BWPs configured in different CCs, in accordance with an example implementation of the present disclosure. As shown in FIG. 8, CC 802 includes DL BWP #0 808, DL BWP #1 810 and UL BWP #0 812; CC 804 includes DL BWP #0 814, DL BWP #1 816 and UL BWP #0 818; and CC 806 includes DL BWP #0 820, DL BWP #1 822 and UL BWP #0 824. In the example implementation illustrated in FIG. 8, CC 802 is a Primary Cell (PCell), and CCs 804 and 806 are SCells. Moreover, CC 804 is a dormant SCell (e.g., the IE of sCellState in the ServingCellconfig in an RRC signaling is set as “dormant”), and CC 806 is an inactive/deactivated SCell.

The serving cell configuration (e.g., the ServingCellconfig) of CC 804 may contain an initial DL BWP configuration and a CSI resource configuration for dormant state (e.g., the CSI-ResourceConfigDormant). The initial DL BWP configuration may include the index of the initial active DL BWP (e.g., BWP ID #0) in CC 804. According to the serving cell configuration of CC 804, the UE (e.g., UE 700 illustrated in FIG. 7) may monitor a CSI resource in DL BWP #0 814 based on the CSI-ResourceConfigDormant when performing CSI measurements. DL BWP #0 814 may be indicated by the index of the initial active DL BWP configured by the initial DL BWP configuration. Once the PHY layer (e.g., PHY layer 706 illustrated in FIG. 7) of the UE receives the CSI resource from DL BWP #0 814, the UE may send a corresponding CSI report to the BS, based on the CSI-ReportconfigDormant of CC 804, through another active BWP/SCell (e.g., UL BWP #0 818 of CC 804).

In some of the present implementations, the CSI resource configuration for dormant state may further contain a BWP ID for the CSI resource of CC 804. In such cases, the UE may follow the procedure described in FIG. 3 or 4 to perform a CSI measurement on the dormant SCell (e.g., CC 804).

For example, when the BWP ID in the CSI resource configuration for dormant state is the same as that in the initial DL BWP configuration, the UE may monitor the CSI resource on a BWP of CC 804. The BWP may be indicated by a BWP ID contained in a CSI resource configuration for dormant state, or contained in an initial DL BWP configuration. Conversely, if the values of these two BWP IDs are different, the UE may treat it as an error case and stop the CSI measurement procedure. In another example, the UE may instruct its PHY layer to monitor the CSI resource on a BWP of CC 804 (e.g., DL BWP #1 816) when the BWP IDs in the CSI resource configuration for dormant state and the initial DL BWP configuration are different. The BWP of CC 804 may be indicated by a BWP ID (e.g., BWP ID #1) contained in the CSI resource configuration for dormant state of CC 804. In another example, the priority of adopting a BWP ID may be reversed. In such a case, the UE may instruct its PHY layer to monitor the CSI resources on a BWP of CC 804 (e.g., DL BWP #0 814 in CC 804) when the BWP ID in the CSI resource configuration for dormant state and the initial DL BWP ID in the serving cell configuration of CC 804 are different. The BWP of CC 804 may be an initial DL BWP (e.g., with BWP ID #0) configured by the serving cell configuration of CC 804.

In some of the present implementations, a UE may monitor a CSI resource in DL BWP #0 814 of CC 804 based on the CSI resource configuration of CC 804 (e.g., the CSI-ResourceConfig). When the PHY layer of the UE receives the CSI resource from CC 804, the UE may send a corresponding CSI report on UL BWP #0 812 of CC 802, based on the CSI report configuration for dormant state (e.g., the CSI-ReportConfigDormant) of CC 804.

In some of the present implementations, the CSI report configuration for dormant state (e.g., the CSI-ReportConfigDormant) used in the various implementations of the present disclosure may be replaced by the CSI-ReportConfig.

In some of the present implementations, the serving cell configuration of CC 804 may include a CSI report configuration for dormant state (e.g., the CSI-ReportConfigDormant). Because the CSI report configuration for dormant state is configured in the same serving cell configuration as the CSI resource configuration for dormant state (e.g., the CSI ResourceConfigDormant), the RRC layer (e.g., RRC layer 702 illustrated in FIG. 7) of the UE may instruct the lower layer (e.g., PHY layer 706 illustrated in FIG. 7) to monitor the CSI resource configured by the CSI resource configuration for dormant state of CC 804.

In some of the present implementations, each of CCs 802, 804 and 806 may be configured with a CSI masking parameter. For example, the CSI masking parameter for CC 802 may be set as “off”, and the CSI masking parameter for CC 804 may be set as “on”. In such a case, the UE may, in a symbol # n, transmit a CSI report for CC 802, but does not transmit a CSI report for CC 804.

In some of the present implementations, assuming that a collision between the CSI report for CC 802 and the CSI report for CC 804 happens in the symbol # n, the UE may calculate the priority value of each CSI report to determine which CSI report should be dropped. In some of the present implementations, the priority value of a CSI report may be calculated according to the following equation:

Pri_{iCSI}(y,k,c,s,offset)=2·N_{cells}·Mₛ·y+N_{cells}·Mₛ·k+Mₛ·c+s+offset (Eq. 1)

In the above equation, Pri_{iCSI} is the priority value of the CSI report, N_{cells} is the value of a higher layer parameter, such as maxNrofServingCells, and Mₛ is the value of a higher layer parameter, such as the maxNrofCSI-ReportConfigurations. According to the equation (1), as the value of the Pri_{iCSI} increases, the priority of the corresponding CSI report may decrease.

In some of the present implementations, different types of CSI reports may correspond to different values of y. For example, y may be set to “0” when the CSI report is an aperiodic CSI report to be transmitted on a PUSCH, may be set to “1” when the CSI report is a semi-persistent CSI report to be transmitted on a PUSCH, may be set to “2” when the CSI report is a semi-persistent CSI report to be transmitted on a PUCCH, or may be set to “3” when the CSI report is a periodic CSI report to be transmitted on a PUCCH. On the other hand, k may be set to “0” for those CSI reports that carry the Layer 1 (L1)-Reference Signal Received Power (RSRP), or may be set to “1” for those CSI reports that do not carry the L1-RSRP. c may be a serving cell index. s may be a report configuration ID (e.g., the reportConfigID). offset may be set to “0” when the serving cell index is not associated with a dormant SCell, or may be set to an arbitrary value which is larger than 0 when the serving cell index is associated with a dormant SCell.

In some of the present implementations, when the UE receives an RRC reconfiguration for configuring a CSI report for CC 804 which occupies Kₜ CPUs, the CSI report for CC 802 may have already occupied Kₛ CPUs. In such cases, assuming that the sum of Kₛ and Kₜ is larger than K_{MAX} (which is the maximum CPU capability of the UE), the UE may calculate the priority value of each CSI report to determine the CSI report that does not need to be updated by the UE. The priority value of each CSI report may be calculated based on, for example, the above-described Equation (1).

In some of the present implementations, the UE may be configured with a trigger state (e.g., the CSI-AperiodicTriggerState) for an aperiodic CSI reporting operation. The trigger state may contain an IE, such as the CSI-AperiodicTriggerStateInfo. If the RRC layer of the UE finds that the CSI report configuration (e.g., the CSI-ReportConfig), which may be associated with the IE of CSI-AperiodicTriggerStateInfo, contains a serving cell ID associated with CC 804, the RRC layer of the UE may find a corresponding CSI resource based on the CSI-ResourceConfigId in the CSI resource configuration for dormant state (e.g., the CSI-ResourceConfigDormant) of the serving cell configuration (e.g., the ServingCellconfig) of CC 804.

In some of the present implementations, if the serving cell ID is associated with a dormant SCell (e.g., CC 804), the UE may apply the CSI resource configuration for dormant state (e.g., the CSI-ResourceConfigDormant) of the serving cell configuration (e.g., the ServingCellconfig) of the dormant SCell (e.g., CC 804) to determine the CSI resource for the CSI measurement. In some of such implementations, the CSI report configuration (e.g., the CSI-ReportConfig) may not contain the CSI-ResourceConfigId, if the serving cell ID is linked to a dormant cell (e.g., CC 804).

In some of the present implementations, the UE may be configured with a trigger state, such as the CSI-SemiPersistentOnPUSCH-TriggerState which contains information, such as the associatedReportConfigInfo that links to a CSI report configuration ID, such as the CSI-ReportConfigId. If the RRC layer of the UE finds that the CSI report configuration (e.g., the CSI-ReportConfig) that is associated with the CSI-AperiodicTriggerStateInfo contains a serving cell ID associated with CC 804, the RRC layer of the UE may find a corresponding CSI resource based on, for example, the CSI report configuration ID (e.g., the CSI-ResourceConfigId) contained in the CSI-ResourceConfigDormant of the ServingCellconfig for CC 804.

In some of the present implementations, if the serving cell ID is associated with a dormant SCell (e.g., CC 804), the UE may apply the CSI resource configuration for dormant state (e.g., the CSI-ResourceConfigDormant) that is contained in the ServingCellconfig for the dormant SCell (e.g., CC 804). It such cases, the CSI report configuration (e.g., the CSI-ReportConfig) may not include a CSI resource configuration ID (e.g., the CSI-ResourceConfigId) if the serving cell ID is linked to a dormant cell (e.g., CC 804).

In some of the present implementations, the UE may be configured with a trigger state such as the CSI-SemiPersistentOnPUSCH-TriggerState which contains information (e.g., the associatedReportConfigInfo) that links to a CSI report configuration ID such as the CSI-ReportConfigId. The RRC layer of the UE may find a corresponding CSI resource based on the CSI report configuration ID (e.g., contained in the CSI-ResourceConfigDormant of the ServingCellconfig for CC 804) if the CSI report configuration ID contains a serving cell ID associated with CC 804.

In some of the present implementations, when the MAC layer of the UE (e.g., MAC layer 704 illustrated in FIG. 7) receives a MAC-CE for activating/deactivating a semi-persistent CSI reporting operation on a PUCCH, the RRC layer of the UE may be informed by the MAC layer to find a CSI report configuration based on a CSI report configuration ID (e.g., the CSI-ReportConfigId) contained in the MAC-CE. The CSI report configuration may contain a serving cell ID referring to CC 804 and a CSI resource configuration ID (e.g., the CSI-ResourceConfigId). The RRC layer of the UE (e.g., RRC layer 702 illustrated in FIG. 7) may find a corresponding CSI resource based on the CSI resource configuration ID. In some of the present implementations, the CSI resource configuration ID may be contained in the CSI resource configuration for dormant state (e.g., the CSI-ResourceConfigDormant) of the serving cell configuration (e.g., the ServingCellconfig) of CC 804. The CSI resource configuration for dormant state (e.g., the CSI-ResourceConfigDormant) may be indicated by the CSI report configuration in the serving cell configuration (e.g., the ServingCellconfig) of CC 804.

In some of the present implementations, each BWP configured to a UE may be individually set to an active state, a dormant state, or a deactivated state. The BS may configure a corresponding CSI resource configuration for each BWP in terms of each BWP's state, and the UE may perform CSI measurement procedures on the BWPs based on the respective CSI resource configurations.

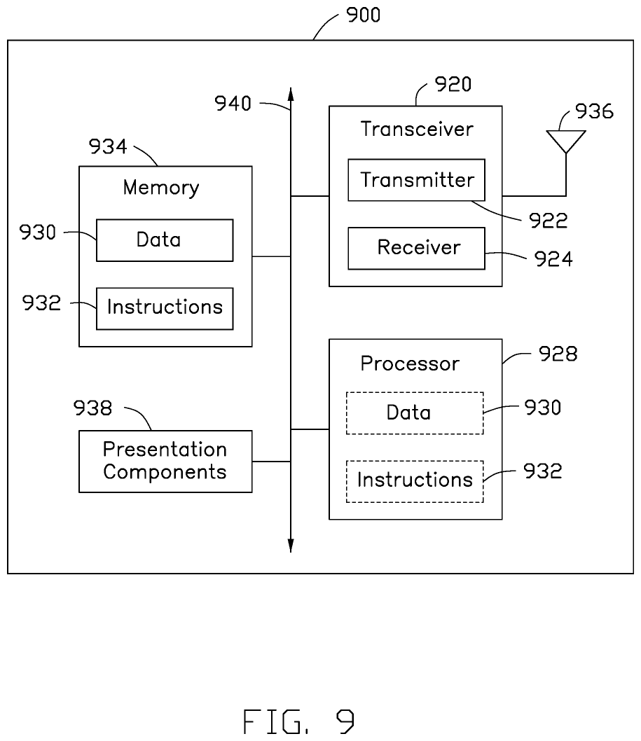

FIG. 9 is a block diagram illustrating a node for wireless communication, in accordance with various aspects of the present disclosure. As shown in FIG. 9, a node 900 may include a transceiver 920, a processor 928, a memory 934, one or more presentation components 938, and at least one antenna 936. The node 900 may also include an RF spectrum band module, a BS communications module, a network communications module, and a system communications management module, Input/Output (I/O) ports, I/O components, and power supply (not explicitly shown in FIG. 9). Each of these components may be in communication with each other, directly or indirectly, over one or more buses 940. In one implementation, the node 900 may be a UE or a BS that performs various functions described herein, for example, with reference to FIGS. 1 through 8.

The transceiver 920 having a transmitter 922 (e.g., transmitting/transmission circuitry) and a receiver 924 (e.g., receiving/reception circuitry) may be configured to transmit and/or receive time and/or frequency resource partitioning information. In some implementations, the transceiver 920 may be configured to transmit in different types of subframes and slots including, but not limited to, usable, non-usable and flexibly usable subframes and slot formats. The transceiver 920 may be configured to receive data and control channels.

The node 900 may include a variety of computer-readable media. Computer-readable media may be any available media that may be accessed by the node 900 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules or data.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 934 may include computer-storage media in the form of volatile and/or non-volatile memory. The memory 934 may be removable, non-removable, or a combination thereof. Example memory includes solid-state memory, hard drives, optical-disc drives, and etc. As illustrated in FIG. 9, The memory 934 may store computer-readable, computer-executable instructions 932 (e.g., software codes) that are configured to, when executed, cause the processor 928 to perform various functions described herein, for example, with reference to FIGS. 1 through 8. Alternatively, the instructions 932 may not be directly executable by the processor 928 but be configured to cause the node 900 (e.g., when compiled and executed) to perform various functions described herein.

The processor 928 (e.g., having processing circuitry) may include an intelligent hardware device, e.g., a Central Processing Unit (CPU), a microcontroller, an ASIC, and etc. The processor 928 may include memory. The processor 928 may process the data 930 and the instructions 932 received from the memory 934, and information through the transceiver 920, the base band communications module, and/or the network communications module. The processor 928 may also process information to be sent to the transceiver 920 for transmission through the antenna 936, to the network communications module for transmission to a core network.

One or more presentation components 938 presents data indications to a person or other device. Examples of presentation components 938 may include a display device, speaker, printing component, vibrating component, etc.

From the above description, it is manifested that various techniques may be used for implementing the concepts described in the present application without departing from the scope of those concepts. Moreover, while the concepts have been described with specific reference to certain implementations, a person of ordinary skill in the art may recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A user equipment (UE) comprising:
one or more non-transitory computer-readable media having computer-executable instructions embodied thereon; and
at least one processor coupled to the one or more non-transitory computer-readable media, and configured to execute the computer-executable instructions to:
receive an instruction indicating a trigger state for Channel Status Information (CSI) reporting from a base station;
determine whether a first Bandwidth Part (BWP) associated with the trigger state is operated in a dormant state in which the UE does not perform data transmissions on the first BWP;
perform a CSI measurement on the first BWP when the first BWP is operated in the dormant state; and
transmit a first CSI report for the first BWP through a second BWP that is operated in an active state.

2. The UE of claim 1, wherein the at least one processor is further configured to execute the computer-executable instructions to:
receive a serving cell configuration for the first BWP from the base station, wherein the serving cell configuration includes a first CSI resource configuration containing a first BWP index and a second CSI resource configuration containing a second BWP index;
determine whether the first BWP index is the same as the second BWP index; and
monitor a CSI Reference Signal (RS) on the first BWP according to the first BWP index when the first BWP index is the same as the second BWP index.

3. The UE of claim 2, wherein the at least one processor is further configured to execute the computer-executable instructions to:
detect a failure of the CSI measurement when the first BWP index is different than the second BWP index.

4. The UE of claim 1, wherein the at least one processor is further configured to execute the computer-executable instructions to:
receive a serving cell configuration for the first BWP from the base station, wherein the serving cell configuration includes a first CSI resource configuration containing a first BWP index and a second CSI resource configuration containing a second BWP index;
determine whether the first BWP index is the same as the second BWP index;
override the second BWP index in the second CSI resource configuration with the first BWP index, when the first BWP index is different than the second BWP index; and
monitor a CSI RS on the first BWP according to the first BWP index to perform the CSI measurement when the first BWP is in the dormant state.

5. The UE of claim 1, wherein the at least one processor is further configured to execute the computer-executable instructions to:
receive a serving cell configuration of the first BWP from the base station, wherein the serving cell configuration includes a first CSI resource configuration containing a first BWP index and a second CSI resource configuration containing a second BWP index;
determine whether the first BWP index is the same as the second BWP index;
override the first BWP index in the first CSI resource configuration with the second BWP index when the first BWP index is different than the second BWP index; and
monitor a CSI RS on the first BWP according to the second BWP index to perform the CSI measurement.

6. The UE of claim 1, wherein the first BWP is an initial DL BWP of a cell.

7. The UE of claim 1, wherein the at least one processor is further configured to execute the computer-executable instructions to:
receive a serving cell configuration containing a first CSI report configuration and a second CSI report configuration from the base station, wherein the first CSI report configuration does not include any serving cell index, and the second CSI report configuration includes a serving cell index;
transmit the first CSI report based on the first CSI report configuration when the first BWP is operated in the dormant state; and
transmit the first CSI report based on the second CSI report configuration when the first BWP is operated in the active state.

8. The UE of claim 1, wherein the at least one processor is further configured to execute the computer-executable instructions to:
receive a CSI masking parameter for controlling whether to transmit the first CSI report within an on-duration of a Discontinuous Reception (DRX) cycle from the base station;
wherein a value of the CSI masking parameter is configured by the base station per a cell basis.

9. The UE of claim 1, wherein the at least one processor is further configured to execute the computer-executable instructions to:
transmit a second CSI report for a third BWP that is operated in the active state; and
prioritize the transmission of the second CSI report over the transmission of the first CSI report.

10. The UE of claim 1, wherein the first CSI report is one of an aperiodic CSI report and a semi-persistent CSI report.

11. A method of wireless communications comprising:
receiving, at a user equipment (UE), an instruction indicating a trigger state for Channel Status Information (CSI) reporting from a base station;
determining, at the UE, whether a first Bandwidth Part (BWP) associated with the trigger state is operated in a dormant state in which the UE does not perform data transmissions on the first BWP;
performing, at the UE, a CSI measurement on the first BWP when the first BWP is operated in the dormant state; and
transmitting, at the UE, a first CSI report for the first BWP through a second BWP that is operated in an active state.

12. The method of claim 11, further comprising:
receiving, at the UE, a serving cell configuration for the first BWP from the base station, wherein the serving cell configuration includes a first CSI resource configuration containing a first BWP index and a second CSI resource configuration containing a second BWP index;
determining, at the UE, whether the first BWP index is the same as the second BWP index; and
monitoring, at the UE, a CSI Reference Signal (RS) on the first BWP according to the first BWP index when the first BWP index is the same as the second BWP index.

13. The method of claim 12, further comprising:
detecting, at the UE, a failure of the CSI measurement when the first BWP index is different than the second BWP index.

14. The method of claim 11, further comprising:
receiving, at the UE, a serving cell configuration for the first BWP from the base station, wherein the serving cell configuration includes a first CSI resource configuration containing a first BWP index and a second CSI resource configuration containing a second BWP index;
determining, at the UE, whether the first BWP index is the same as the second BWP index;
overriding, at the UE, the second BWP index in the second CSI resource configuration with the first BWP index, when the first BWP index is different than the second BWP index; and
monitoring, at the UE, a CSI RS on the first BWP according to the first BWP index to perform the CSI measurement when the first BWP is in the dormant state.

15. The method of claim 11, further comprising:
receiving, at the UE, a serving cell configuration of the first BWP from the base station, wherein the serving cell configuration includes a first CSI resource configuration containing a first BWP index and a second CSI resource configuration containing a second BWP index;
determining, at the UE, whether the first BWP index is the same as the second BWP index;
overriding, at the UE, the first BWP index in the first CSI resource configuration with the second BWP index when the first BWP index is different than the second BWP index; and
monitoring, at the UE, a CSI RS on the first BWP according to the second BWP index to perform the CSI measurement.

16. The method of claim 11, wherein the first BWP is an initial DL BWP of a cell.

17. The method of claim 11, further comprising:
receiving, at the UE, a serving cell configuration containing a first CSI report configuration and a second CSI report configuration from the base station, wherein the first CSI report configuration does not include any serving cell index, and the second CSI report configuration includes a serving cell index;
transmitting, at the UE, the first CSI report based on the first CSI report configuration when the first BWP is operated in the dormant state; and
transmitting, at the UE, the first CSI report based on the second CSI report configuration when the first BWP is operated in the active state.

18. The method of claim 11, further comprising:
receiving, at the UE, a CSI masking parameter for controlling whether to transmit the first CSI report within an on-duration of a Discontinuous Reception (DRX) cycle from the base station;
wherein a value of the CSI masking parameter is configured by the base station per a cell basis.

19. The method of claim 11, further comprising:
transmitting, at the UE, a second CSI report for a third BWP that is operated in the active state; and
prioritizing, at the UE, the transmission of the second CSI report than the transmission of the first CSI report.

20. The method of claim 11, wherein the first CSI report is one of an aperiodic CSI report and a semi-persistent CSI report.
